(19) United States
(12) Patent Application Publication
(10) Pub. No.: US 2008/0120257 A1
(43) Pub. Date: May 22, 2008

(54) Automatic online form filling using semantic inference

(75) Inventors: Amit Goyal, Kota (IN); Gajendra Nishad Kamat, Bangalore (IN); Shouvick Mukherjee, Koramangla (IN)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/702,848

(22) Filed: Feb. 5, 2007

(30) Foreign Application Priority Data
Nov. 20, 2006 (IN) 2495/DEL/2006

(51) Int. Cl. G06F 15/18

(52) U.S. Cl. 706/12

(57) ABSTRACT

A machine learning based automated online form-filling technique provides for automatically completing user input controls based on previously stored information. An associative parser is used to identify and associate characteristics related to form controls with the corresponding form controls. The characteristics of the user input controls are input into a machine learning based semantic inference engine that was trained for the purpose of identifying the type of information that is supposed to be input into various user input controls. The semantic inference engine operates to label the controls in a manner that describes the meaning of the control, i.e., the type of information that should be automatically input into the corresponding controls. Consequently, the user input controls can be automatically filled in with previously stored user profile information associated with the corresponding labels.

### CROSS REFERENCE TO RELATED APPLICATIONS

This application is related to and claims the benefit of priority from Indian Patent Application No. 2495/DEL/2006 filed in India on Nov. 20, 2006, entitled “AUTOMATIC ONLINE FORM FILLING USING SEMANTIC INFERENCE”; the entire content of which is incorporated by this reference for all purposes as if fully disclosed herein.

### FIELD OF THE INVENTION

The present invention relates to automatic online form-filling using a machine learning based semantic inference engine.

### BACKGROUND OF THE INVENTION

Many daily activities are performed using online applications, such as web server-based applications. Many of these server-based applications require client users to submit one or more forms to the server for the applications to function properly. For example, online forms can be associated with retail purchasing, taxes, bill payments, immigration, ticket booking, hospitals, registration, jobs, etc., and most often are presented to the client user inf the form of an HTML Form. Thus, online forms represent a primary component for offering useful commercial and non-commercial services online, i.e., over a network.

There is a general aversion to completing, or “filling”, online forms. This is especially true when the information the form requires is redundant with information already entered into another form, application, or system. Hence, there is demand for automatic form filling tools. However, some approaches to automatic form filling may be limited in their operational scope and accuracy, such as in their ability to accurately identify the purpose of various form input fields (also referred to in HTML as “form controls” and “controls”) This is especially true in the context of filling forms having arbitrary schemas.

For example, an approach that relies on literal analysis of control labels would experience reduced effectiveness when encountering even slight variations in the literal relationship between the controls and corresponding labels. For example, hard-coding variations of terms into the logic of a form-filling tool might work fine as long as all variations of the terms are known beforehand. However, when an unknown label is encountered, such a tool would fail to fill that corresponding field. For another example, an approach that relies on analysis of the relative proximity of HTML form controls and associated HTML tags as embodied in the actual HTML code, would not likely produce accurate results when analyzing less structured or “arbitrary” forms, such as a form that contains a single label for three input fields (e.g., three input fields associated with the single label “name”).

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a system 100 for automatically completing an online form, according to an embodiment of the invention;

FIG. 2 is a flow diagram that illustrates a method for automatically filling an online form, according to an embodiment of the invention; and

FIG. 3 is a block diagram that illustrates a computer system upon which an embodiment of the invention may be implemented.

### DETAILED DESCRIPTION OF EMBODIMENTS OF THE INVENTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Functional Overview of Embodiments

A machine learning based online form-filling technique provides for automatically completing online forms based on previously stored information. An associative parser is used to identify and associate characteristics related to form controls with the corresponding form controls (also referred to herein as “user input controls”). For non-limiting examples, the associative parser may associate an HTML <label> element, a caption, and/or an example input format with a particular HTML text input control. The characteristics of the user input controls are input into a machine learning mechanism or process that was trained for the purpose of identifying the type of information that is supposed to be input into various user input controls. For example, for a given online form, the type of each control and a corresponding set of related tokens (i.e., an “observation sequence”) are used as input to a semantic inference engine, for semantic interpretation of the observation sequence. The semantic inference engine operates to “label” the controls in a manner that describes the meaning of the control, i.e., the type of information that should be automatically input into the corresponding controls. Consequently, the user input controls can be automatically filled in with previously stored information associated with the corresponding labels.

Often, online forms are created based on an HTML table element. If the online form is well structured as an HTML table, then a table-based associative parser is used, which generously investigates neighboring elements. However, if the online form is only a loosely structured HTML table or is not created based on a table, then a polar parser is used. The polar parser exploits the principle that there is typically proximity between a control and associated information such as a corresponding HTML <label> element, when rendered in a browser.

Generally, the form-filling techniques described herein understand the semantics and recognize the meaning of <label> and other elements associated with user input controls, as well as the visual progression of such elements. For example, the machine learning based semantic inference engine “knows” that in most forms a ‘name’ control typically precedes ‘address’ controls, and deduces the relevant subject matter of various controls based on this knowledge. Hence, these techniques are capable of completing many more controls, and with much higher accuracy, than might be possible using other approaches.

### Automated Online Form Filling

User input controls are form controls designed to receive user input. HTML is described in “HTML 4.01 Specification, W3C Recommendation 24 Dec. 1999” (the “HTML specification”) available from the W3C organization, the content of which is incorporated by reference in its entirety for all purposes as if fully disclosed herein. The HTML specification defines the following control types: buttons, checkboxes, radio buttons, menus, text input, and file select. However, embodiments of the invention may be used to automatically complete types of controls other than those described in the HTML specification and to automatically complete forms other than forms constructed in HTML.

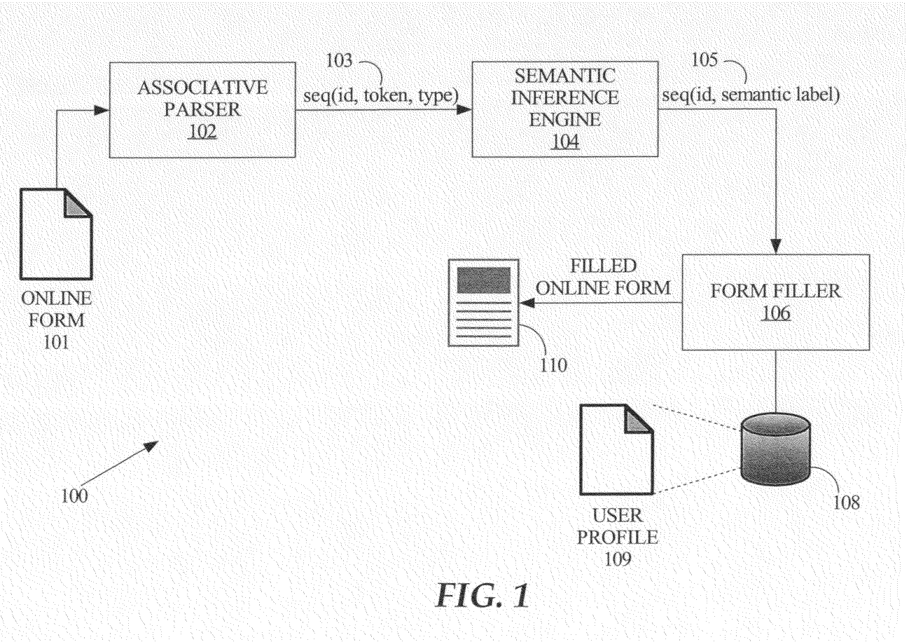

FIG. 1 is a block diagram that illustrates a system 100 for automatically completing an online form, according to an embodiment of the invention. FIG. 1 depicts an online form 101 as input to an associative parser 102, a semantic inference engine 104, a form filler 106, a data store 108 that stores a user profile 109, and a filled online form 110.

The architecture according to which the system 100 is configured may vary from implementation to implementation. For example, according to a preferred implementation, the associative parser 102 operates on a client machine while the semantic inference engine 104 operates on a server machine. However, both the associative parser 102 and the semantic inference engine 104 may operate on a client machine or both may operate on a server machine. Furthermore, the form filler 106 may operate on a client machine or on a server machine, which may be based on which of the client and server is more closely coupled with the data store 108. For example, if a user of the techniques described herein chooses to store a corresponding user profile in a data store 108 associated with the server machine, then form filler 108 may be configured to operate on the server machine. Alternatively, if a user of the techniques described herein chooses to store a corresponding user profile in a data store 108 associated with the client machine, then form filler 108 may be configured to operate on the client machine. Regardless of whether the data store 108 is communicatively coupled to a client machine or to a server machine, the data store 108 may be integrated within the client or server, or the data store 108 may be external to the client or server.

Associative Parser

Observation has shown that an online form, such as online form 101, has human readable string labels usually adjacent to human enterable HTML form control elements. Generally, the associative parser 102 associates such string labels to the HTML form elements without user intervention. According to one embodiment, the associative parser uses a browser-based DOM (document object model) for understanding the structure of a web page and any forms contained therein, such as online form 101. Associative parser 102 traverses the DOM tree to identify user input controls and related “tokens”, where a token refers to elements or information that may help the semantinc inference engine 104 determine the meaning of the various user input controls. For example, a set of tokens associated with a particular user input control, which is identified by its HTML form control “id”, may include (a) an HTML <label> element determined to be associated with the user input control, and (b) a set of possible values for the user input control extracted from a menu corresponding to the user input control.

According to one embodiment, associative parser 102 outputs an association between a user input control identifier and a set of tokens which, at a minimum, contains a <label> element determined to be associated with the control. According to one embodiment, associative parser 102 outputs an association between a user input control identifier, a set of tokens, and the type of the user input control.

The control type can be used by the semantic inference engine 104, for example, to know whether the information that is to be filled into the corresponding user input control is constrained to a certain subset of information, and/or to infer semantic meaning of the corresponding user input control. For example, form controls for “state” of residence are typically menu controls, form controls for “name” are typically text input controls, and form controls for “gender” are typically checkbox controls. Therefore, the semantic inference engine 104 can use the knowledge that a particular control is a menu, text input, or checkbox control to aid in the semantic inference process.

An online form 101 can be structured in any arbitrary schema. Observation has shown that many forms on the web are structured in a table-based schema. Thus, according to one embodiment, associative parser 102 comprises two parsers. One associative parser is used for table-based schemas and is referred to herein as an enhanced table-based parser. Another associative parser is used for any arbitrary schemas and is referred to herein as a polar parser.

Enhanced Table-Based Parser

Table-based forms are already structured in the form of a grid of cells, therefore the enhanced table-based parser “generously” grabs elements in neighboring cells to a user input control, such as when a single <label> element denotes multiple HTML form elements (e.g., <label> name </label> associated with all three of ‘first name’, ‘middle initial’, and ‘last name’ fields). The <label> element could be in any direction relative to the user input control element. However, heuristics dictate an order in which to search for a related <label> element and other related tokens, as follows. According to one embodiment, the enhanced table-based parser first searches for relevant tokens in the west cell (i.e., left of the control) and then in the north cell (i.e., above the control). According to one embodiment, the enhanced table-based parser then searches for relevant tokens in the south direction (i.e., below the control) and in the east direction (i.e., right of the control), for non-limiting examples, for captions and extra information such as form control formats (e.g., in case of date of birth, country code, area code, etc.).

Polar Parser

According to one embodiment, if the online form 101 is not constructed as a table, or the table is loosely structured or not structured in the proper manner, the online form 101 is processed for visual cues. As the form is normally meant for human processing, there is typically some degree of physical adjacency between a user input control and a corresponding <label> element, when graphically rendered. Thus, the polar parser exploits this principle and logically arranges all <label> elements and the user input controls at the same positions as a browser would.

The polar starts with a user input control and “draws” an imaginary border of territory around the user input control, based on the coordinates of elements as they would be graphically rendered by a browser. The (x,y) coordinates of elements in a web page are routinely derived from the code underlying the web page, such as when a browser renders the web page. When the polar parser encounters an element, i.e., a possible token, in the bounded territory, the parser then determines whether the element is likely associated with the user input control. According to one embodiment, the polar parser considers elements in that territory in the following order of precedence: west (e.g., left of the control), north (e.g., above the control), south (e.g., below the control), and east (e.g., right of the control). For example, the polar parser searches for the <label> elements in the west and north directions, and searches for caption and extra information such as input format information in the south and east directions. However, the order in which the polar parser searches for tokens may vary from implementation to implementation. For example, the foregoing order can be changed to accommodate forms written in other languages such as Hebrew.

According to one embodiment, the polar parser starts with a bounded set of elements one level away from the user input control in every direction and, if no relevant tokens are found in this initial bounded set, then the bounded set of elements is systematically expanded in every direction one level at a time.

Some user input controls do not have a unique associated <label> element, i.e., there is not necessarily a one-to-one mapping between user input control fields and <label> elements in a give web page. For examples, a single “name” label is often associated with three different user input controls, for first name, middle name, and last name; and/or a single “dependents” label may be associated with multiple user input controls. Hence, some user input controls “borrow” a label based on the label's association with another related user input control. Stated otherwise, it is possible for a particular <label> element to be associated with a set of contiguous multiple user input controls, where, for example, the third control borrows the token from the second control, which borrows the same token from the first control. However, even though the associative parser 102 associates a common token with multiple user input controls, the semantic inference engine 104 will assign a unique identifier label to each of the multiple controls.

Asynchronous JavaScript® and XML (AJAX)

As mentioned, according to various embodiments, associative parser 102 outputs an association between a user input control identifier and a set of tokens or an association between a user input control identifier, a set of tokens, and the type of the user input control. This information is sent from the associative parser 102 to the semantic inference engine 104 for further processing.

In an implementation in which the associative parser 102 is configured on a client machine and the semantic inference engine 104 is configured on a server machine, according to one embodiment, the data structures and associated contained information sent from associative parser 102 to semantic inference engine 104 is transmitted using Asynchronous JavaScript® and XML (AJAX). Likewise, and in response, the data structures and associated contained information sent from semantic inference engine 104 to associative parser 102 is also transmitted using AJAX. Using AJAX, it is possible to send and receive the information in an efficient manner without user intervention and without distracting the user from the task at hand. Hence, the client user can continue working within the same window while the semantic inference engine 104 is characterizing the meaning of the user input controls for which data was sent to the server. Using AJAX provides a relatively transparent communication process for the client user, and ensures fast and efficient transfer of data between client and server.

Semantic Inference Engine

The semantic inference engine 104 processes the semantic meaning of each user input control of online form 101, based on the information from the associative parser 102. As described herein, the associative parser outputs a sequence of information that characterizes an online form 101. As described, associative parser 102 provides semantic inference engine 104 a sequence 103 representing characteristics of user input controls from online form 101, comprising for each user input control being processed: (a) a user input control identifier, (b) an associated set of one or more tokens, and possibly (c) the type of the user input control. Based on the sequence 103 of information (also referred to as an “observation sequence”) provided by associative parser 102, semantic inference engine 104 computes the “meaning” of each user input control from online form 101, in order to generate an associated semantic label for each user input control. The semantic labels generated by semantic inference engine 104 effectively identify the type of data that should be used to complete the corresponding user input control.

For example, based on a three-part user input control, such as for a phone number, associative parser 102 may output a sequence that includes [id=phonenumber1, tokens=phone_no, (xxx); id=phonenumber2, tokens=phone_no, xxx; id =phonenumber3, phone_no, xxxx) (shown in a pseudo-form). The foregoing partial sequence for the three phone number user input controls characterizes each of the three user input control fields (identified by their corresponding HTML form ids as “phonenumber1”, “phonenumber2”, and “phonenumber3”), along with corresponding tokens. In this example, the tokens include the single HTML <label> element that corresponds to all three user input control fields (<label> phone_no </label>), as well as a format corresponding to each of the three user input control fields (“(xxx)” for phonenumber1, “xxx” for phonenumber2, and “xxxx” for phonenumber3). Semantic inference engine 104 may return a sequence that includes [id phonenumber1, Area Code; id=phonenumber2, 3 Digit Subscriber Number Set; id=phonenumber3, 4 Digit Subscriber Number Set] (shown in pseudo-form).

For another example, based on a single field user input control, such as for a date, associative parser 102 may output a sequence that includes [id=date, tokens=date, mm/dd/yyyy] (shown in a pseudo-form). The foregoing partial sequence for the user input control characterizes the user input control (identified by the corresponding HTML form id as “date”), along with corresponding tokens. In this example, the tokens include the HTML <label> element that corresponds to the user input control field (<label> date </label>), as well as a format corresponding to the user input control field (mm/dd/yyyy). Semantic inference engine 104 may return a sequence that includes [id=date, Single Field Date: Month/Day/4 Digit Year] (shown in pseudo-form).

According to one embodiment, semantic inference engine 104 is a machine learning mechanism. As a broad subfield of artificial intelligence, machine learning is concerned with the development of algorithms and techniques that allow computers to “learn”. As with most machine learning techniques, the machine learning mechanism of semantic inference engine 104 needs to be “trained” on how to produce desired results. Generally, training a machine learning mechanism includes running a training set of information through the machine learning mechanism so that the mechanism can learn about the type of input information that the mechanism will be expected to analyze, e.g., how to interpret, analyze, and base decisions on such types of information. Further, because the semantic inference engine 104 utilizes a machine learning mechanism, the information learned from one online form can be applied to other online forms. Stated otherwise, if the semantic inference engine 104 made a mistake in the past, it is very unlikely to repeat such a mistake in the future.

Once computed, semantic inference engine 104 outputs a set, or sequence 105, of semantic labels corresponding to the user input controls that were characterized in the input sequence 103. According to one embodiment, the sequence 105 of semantic labels is output to form filler 106.

Conditional Random Fields

There are many different types of machine learning techniques currently developed and currently being developed. For non-limiting examples, Artificial Neural Networks, Support Vector Machines, Hidden Markov Models, Maximum Entropy Markov Models, and Conditional Random Fields all refer to different types of machine learning techniques. Experimentation leading to embodiments of the invention has proved that an effective machine learning mechanism for accurately labeling form controls is based on conditional random fields (CRF), a probabilistic framework for segmenting and labeling structured data. Thus, for semantic interpretation of the string labels, according to one embodiment, the machine learning technique referred to as Conditional Random Fields (CRF) is used. Use of CRF enables the semantic inference engine 104 to recognize the schema space of the online form 101, and provides more accuracy and thus trustworthy recall values than with other approaches to automatic form fillers.

The framework of Conditional Random Fields is described in (1) “Conditional Random Fields: Probabilistic Models for Segmenting and Labeling Sequence Data” (In International Conference on Machine Learning, 2001) by Lafferty et al., and (2) “Conditional Random Fields: An Introduction” (CIS Technical Report MS-CIS-04-21, University of Pennsylvania, Feb. 24, 2004) by Wallach, the content of both of which is incorporated by reference in its entirety for all purposes as if fully set forth herein. As mentioned, machine learning mechanisms need to be trained to produce desired results. There are multiple approaches to training a CRF machine learning mechanism, some of which are described in (1) “Shallow Parsing with Conditional Random Fields” (Technical Report CIS TR MS-CIS-02-35, University of Pennsylvania, 2003) by Sha et al., (2) “Efficient Training of Conditional Random Fields” (Master's thesis, University of Edinburgh, 2002) by Wallach, and (3) “Training Conditional Random Fields via Gradient Tree Boosting” (In International Conference on Machine Learning, 2004) by Dietterich et al., the content of all of which is incorporated by reference in its entirety for all purposes as if fully set forth herein.

Generally, for information that progresses in a particular direction (i.e., a sequence), where each element in the sequence is a variation of a similar or related term, CRF makes logical sense of the information using knowledge of other similar structures. For example, numerous online retailer web sites may use a similar layout, in which an image of the product precedes (from left to right) the title and price of the product (title above price) and where user reviews of the product appear below the image, title, and price. Thus, with training, a CRF mechanism can understand that user reviews almost always appear after the image of a product and can perform deductive reasoning based on that understanding.

Conditional Random Fields (CRF) refers to a probabilistic framework for labeling and segmenting structured data, such as sequences, trees and lattices. CRF defines conditional probability distributions p(Y/X) of label sequences (e.g., sequence 105) given input sequences (e.g., sequence 103). X is a random variable over an input data sequence to be labeled, and Y is a random variable over a corresponding label sequence. For example, X is a random variable over the sequence 103 of user input control characteristics input into semantic inference engine 104, and Y is a random variable over a corresponding semantic label sequence considered and possibly output (e.g., sequence 105) from semantic inference engine 104.

A CRF is an undirected graphical model in which each vertex represents a random variable whose distribution is to be inferred, and each edge represents a dependency between two random variables. In a CRF, the distribution of each discrete random variable Y in the graph is conditioned on an input sequence X. In principle, the layout of the graph of random variables Y can be arbitrary; most often, however, the Yᵢ are structured to form a chain, with an edge between each Yᵢ₋ₗ and Yᵢ. In addition to having a simple interpretation of the Yᵢ as labels for each element in the input sequence, this layout admits efficient algorithms for model training, learning the conditional distributions between the Yᵢ and feature functions from some set of training data (i.e., inference), determining the probability of a given label sequence Y given X and, therefore, determining the most likely label sequence Y given X. The conditional dependency of each Yᵢ on X is defined through a fixed set of feature functions of the form f(i,Yᵢ₋ₗ,Yᵢ,X), which are akin to measurements on the input sequence that partially determine the likelihood of each possible value for Yᵢ. The model assigns each feature a numerical weight and combines the weights to determine the probability of a certain value for Yᵢ.

Hence, a CRF is specified by a vector f of local features and a corresponding weight vector λ. Each local feature is either a state feature s(y,x,i) or a transition feature t(y,y′,x,i), where y and y′ are semantic labels, x is an input sequence, and i is an input position. The weight vector λ is estimated from the training data. Features depend on input data and other environmental properties. For example, a state feature is specific to a particular user input control and depends on the properties of the current state only, e.g., the current observation such as tokens, type of the user input control, etc., for that user input control. The state feature is independent of other states associated with other user input controls. A transition feature represents the interaction between successive states, conditioned on the observation, e.g., the relationship between the labels “first name” and “middle name”. The weight vector helps in determining the likelihood of a particular meaning for a corresponding user input control by assigning a relative significance to each feature, which is then used to calculate the probability of a particular label sequence based on this weight vector.

Generally, the semantic inference engine 104 CRF mechanism considers each token from the input sequence 103 to infer meaning from the input sequence, and applies weights to features (i.e., state and transition features) that are applicable in the current state for corresponding user input controls. For each user input control under consideration, the semantic inference engine 104 determines a state, which is a possible semantic label for the user input control. All reasonably possible states are considered and the probability of each is computed, in view of the probability of transitioning from one state to the next, starting with a likely state and moving to a next likely state, and so on. Thus, with at least a set of user input control based tokens (i.e., a set of words) as input, the semantic inference engine 104 outputs semantic labels for corresponding user input controls.

The CRF's global feature vector for input sequence x and label sequence y is given by

F(y,x)=Σᵢf(y,x,i)

where i ranges over input sequences. The conditional probability distribution defined by CRF is

p_{λ}(Y/X)={exp λ.F(Y/X)}/Z_{λ}(X),

where

Z_{λ}(X)=Σ_{y}exp λ.F(y/x).

CRF is trained by maximizing the log-likelihood of a giving training set T={(xₖ,yₖ)}, k=1 to N which is given by

L(λ)=Σₖlog p_{λ}(y_{k/}xₖ).

Once the training is completed, the model is ready to use. The weight vector λ is now known and, given the observation sequence, the probabilities of transition from one finite state to another can be processed. In the particular context of the automatic online form filler described herein, given the HTML user input control fields and their corresponding tokens in a sequential order (the observation sequence), the semantic meaning of the user input controls can be processed to produce the semantic label sequence.

Online Form Filler

Form filler 106 receives the sequence 105 of semantic labels from semantic inference engine 104. Because the semantic labels effectively characterize the meaning of the corresponding user input controls, the semantic labels identify what type of information or data is supposed to be input into the various user input controls. Thus, the semantic labels are considered data identifiers, so that form filler 106 can use the semantic labels to identify corresponding data for automatic input into the user input controls for online form 101.

User profile 109 is a set of information about a particular user, which has been entered into system 100 and stored in data store 108. User profile 109 is not limited in its scope and, therefore, can contain all kinds of information about the user. Thus, user profile can contain information related to one or more domains. For non-limiting examples, user profile 109 may contain a user's personal contact information (e.g., name, residence address, shipping address, phone number, email address), academic/career related information (e.g., information typically contained in a resume), travel preferences, shopping preferences, financial/banking/billing information, immigration information, and the like. Data store 108 is considered an extensible storage mechanism because, via the user profile 109, data store 108 contains values for any number of user input controls, where such values are not tied to any particular online form.

Form filler 106 uses the semantic labels as an index for, or a key into, user profile 109 stored in data store 108. For example, a database containing user profiles 109 may contain records identified in a manner corresponding to the semantic labels. For a non-limiting example, database tables may comprise rows or columns that are identified by, or map to, corresponding semantic labels output by semantic inference engine 104. Generally, user profile 109 is stored in data store 108 in a manner such that form filler 106 can identify the correct information from user profile 109 for input to online form 101, based on the semantic labels.

As mentioned, users may be given a choice as to where they want to store their user profile, i.e., on their client machine or on a server machine. Consequently, the system 100 may be configured with a form filler 106 and data store 108 on one or the other, or both, client and server machines. In the case in which user profile 109 and form filler 106 reside on a client machine, semantic inference engine 104 returns the semantic labels to the client machine for input into online form 101, to generate a “filled” online form 110. The user input controls contained in filled online form 110 are completed as much as possible based on the semantic labels and the user profile 109. In the case in which user profile 109 and form filler 106 reside on a server machine, semantic inference engine 104 returns the “filled” online form 110 to the client.

### A Method for Automatically Filling an Online Form

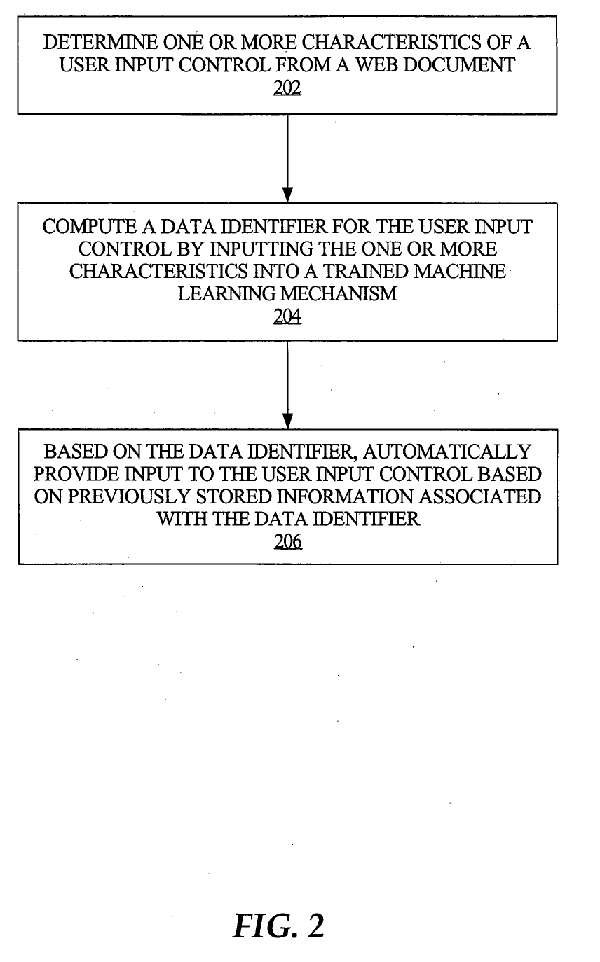

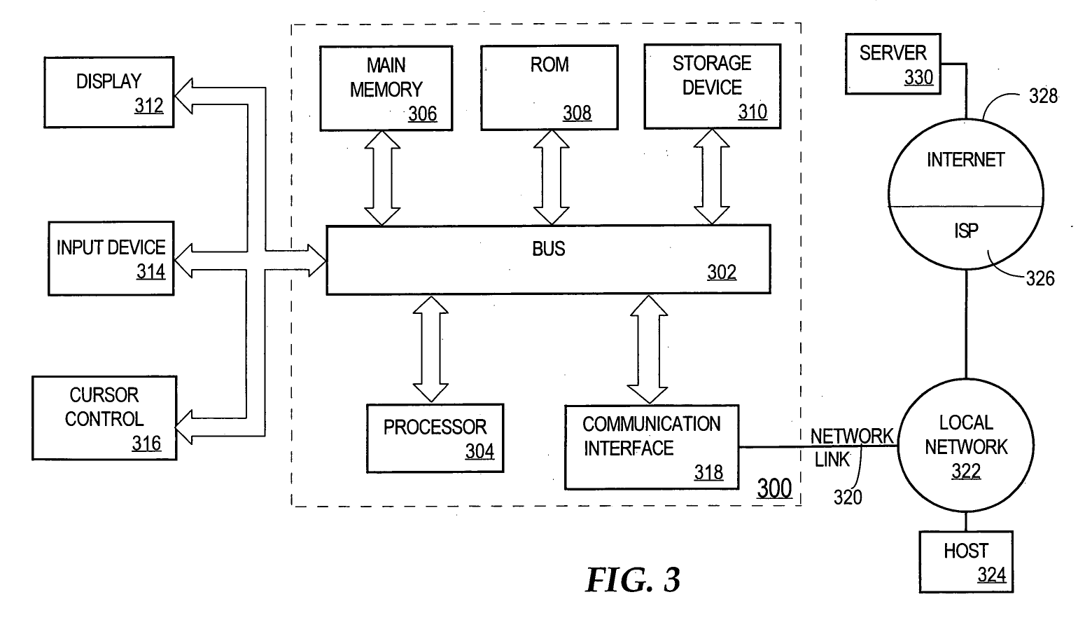

FIG. 2 is a flow diagram that illustrates a method for automatically filling an online form, according to an embodiment of the invention. In this context, “filling” refers to inputting information in one or more user input controls in an online form. The method depicted in FIG. 2 is a computer and/or machine-implemented method in which a computer or machine performs the method, such as by one or more processors executing instructions. For example, the method may be performed on or by a computer system such as computer system 300 of FIG. 3. Furthermore, the method may be performed by executing instructions constituent to a server-based software application, a client-based software application, or any combination of the foregoing applications.

At block 202, one or more characteristics of a user input control are determined. For example, associative parser 102 (FIG. 1) searches a web page via a DOM to identify any forms in the web page and the various controls within such forms. Once user input controls are identified, a set of one or more tokens associated with respective controls is generated, where the tokens represent characteristics of the respective controls. As described herein, non-limiting examples of tokens include HTML <label> elements, captions, format descriptions, etc., that are determined to be associated with a given user input control element. Because the associative parser 102 exploits the human nature of associating things by their distance, determining characteristics of a user input control does not depend entirely on the programmatic structure of the form.

At block 204, a data identifier is computed for the user input control by inputting the one or more characteristics into a previously trained machine learning mechanism. For example, semantic inference engine 104 (FIG. 1) takes as input a sequence that is output from associative parser 102 (FIG. 1), and processes the input sequence using a machine learning mechanism, such as CRF. The data identifier is also referred to herein as a semantic label because it identifies a type of data for input to the user input control based on the inferred/deduced semantic meaning associated with the user input control. As depicted in FIG. 1, the semantic inference engine may output a sequence 105 of semantic labels corresponding to the sequence 103 of input user control information.

At block 206, based on the data identifier computed at block 204, input to the user input control is automatically provided, where the input is based on previously stored information associated with the data identifier. For example, form filler 106 (FIG. 1) automatically completes one or more of the user input controls in online form 101 (FIG. 1) with information from a user profile 109 (FIG. 1) stored in data store 108 (FIG. 1), thereby generating filled online form 110 (FIG. 1).

The foregoing automatic form filling process is completely automated and therefore inexpensive to maintain, and the process is extendible to online forms of different vertical web sites, different languages, and different locales.

### Hardware Overview

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

### Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

Alternative embodiments of the invention are described throughout the foregoing specification, and in locations that best facilitate understanding the context of the embodiments. Furthermore, the invention has been described with reference to specific embodiments thereof. It will, however, be evident that various modifications and changes may be made thereto without departing from the broader spirit and scope of the invention.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

What is claimed is:

1. A method comprising performing a machine-executed operation involving instructions, wherein said instructions are instructions which, when executed by one or more processors, cause the one or more processors to perform certain steps including:
determining one or more characteristics associated with a user input control that is in a web document;
computing a data identifier for said user input control by inputting said one or more characteristics into a machine learning mechanism that has been previously trained based on a training set; and
based on said data identifier, automatically providing input to said user input control based on previously stored information associated with said data identifier;
wherein the machine-executed operation is at least one of (a) sending said instructions over transmission media, (b) receiving said instructions over transmission media, (c) storing said instructions onto a machine-readable storage medium, and (d) executing the instructions.

2. The method of claim 1, wherein determining comprises determining a characteristic of said user input control based on what would be the spatial location of an element in said web document relative to said user input control when said web document is graphically rendered.

3. The method of claim 2, wherein said element is an HTML label element.

4. The method of claim 2, wherein determining comprises first determining whether said element is to the left of said user input control and, if said element is not to the left of said user input control, then determining whether said element is above said user input control.

5. The method of claim 1, wherein determining comprises using a table-based parser to identify label elements associated with said controls.

6. The method of claim 5, wherein determining comprises determining whether a caption and/or format element associated with said user input control is to the right of or below said user input control.

7. The method of claim 1, wherein computing comprises inputting said one or more characteristics into a machine learning mechanism based on conditional random fields.

8. The method of claim 1, wherein said one or more characteristics of said user input control includes (a) a unique identifier for said user input control and (b) an associated element in said web document.

9. The method of claim 8, wherein said unique identifier is an HTML “id” corresponding to said user input control and said associated element is an HTML “label” element corresponding to said user input control.

10. The method of claim 1, wherein said one or more characteristics of said user input control includes (a) a unique identifier for said user input control, (b) a label element associated with said user input control in said web document, and (c) a control type corresponding to said user input control.

11. The method of claim 1, wherein said one or more characteristics of said user input control includes (a) a unique identifier for said user input control, (b) a label element associated with said user input control in said web document, (c) a control type corresponding to said user input control, and (d) possible values for said user input control based on options associated with a menu type of user input control in said web document.

12. The method of claim 1, wherein said one or more characteristics of said user input control includes (a) a set of words, and (b) a control type corresponding to said user input control.

13. The method of claim 1, wherein said determining is performed by a client-side application and said computing is performed by a server-side application.

14. The method of claim 13, wherein said instructions are instructions which, when executed by one or more processors, cause the one or more processors to perform certain steps including:
transmitting said one or more characteristics from said client application to said server application using Asynchronous JavaScript® and XML (AJAX).

15. The method of claim 1, wherein said web document is constructed in a non-English language.

16. The method of claim 1, wherein said instructions are instructions which, when executed by one or more processors, cause the one or more processors to perform certain steps including:
instructing said machine learning mechanism about a mistake that said machine learning mechanism made in computing a data identifier for a user input control to further train said machine learning mechanism.
